(19) United States
(12) Patent Application Publication
(10) Pub. No.: US 2021/0281354 A1
(43) Pub. Date: Sep. 9, 2021

(54) METHOD AND APPARATUS FOR DETECTING AND JAMMING TRANSMITTERS AND RECEIVERS

(71) Applicant: ATLETOR AB, 852 30 Sundsball (SE)

(72) Inventor: Torbjörn OLSSON, Sundsball (SE)

(73) Assignee: ATLETOR AB, 852 30 Sundsball (SE)

(21) Appl. No.: 16/610,847

(22) PCT Filed: May 15, 2018
(86) PCT No.: PCT/SE2018/050499

§ 371 Date: Nov. 4, 2019

(30) Foreign Application Priority Data
May 17, 2017 (SE) 1700098-5

(51) Int. Cl. H04K 3/00

(52) U.S. Cl. CPC H04K 3/42; H04K 3/44; H04K 3/45; H04K 2203/32; H04K 2203/14; H04K 2203/18; H04K 2203/12

(57) ABSTRACT

A method to detect and jars an electromagnetic transmission includes detecting electromagnetic radiation from an electromagnetic radiating source, determining the type of the received electromagnetic radiation by comparing the signature of the received signal with signatures from a database, selecting the waveform and frequency to disturb the determined type, and transmitting a waveform with a frequency to jam the electromagnetic transmission. A system to jam an electromagnetic transmission is also provided.

### TECHNICAL FIELD

The invention relates to a method to detect and jam an electromagnetic transmission. The invention further relates to a system to detect and jam an electromagnetic transmission.

### BACKGROUND AND SUMMARY

Radio Frequency (RF) transmitters and receivers have become widely available and deployed for use in many, both military and civilian, applications. Examples are cellular phones, aerial drones, satellite navigation and wireless data networks. Collectively, the possible existence of many different RF transmissions from many different types of equipment presents a broadband RF transmission environment. Commonly frequency ranges of transmitted signal, depending upon transmitter technology, varies from kHz to THz. The transmitters and receivers are hereafter referred to as wireless devices.

Due to the increasing lame deployment of many different types of wireless devices, the particular RF signals and signal protocols that may be present in any particular local area have a potential to be quite complex and spanning an extensive frequency range.

Some of these wireless devices might be used for illegal purposes, or by a military adversary. It is thus of interest to locate and/or to prevent further usage of a particular wireless device. It is furthermore of interest to be able to act rapidly on a threat. Preferably a local capability to directly act upon an opponent is desired. Time is often crucial for a successful operation.

For example: Illegal usage of aerial drones could be anything from carrying explosives for acts of terrorism to flying in restricted airspace. Such felonies call for instant action. Not just preventing the deed, but also apprehending the perpetrator. Suitable man carried easy deployable tools to accomplish this dual purpose is non-existent today.

In order to accomplish the above, a system will need to have the following capabilities:

Determine the existence and position of a certain wireless device

Jam the radio connection to the wireless device

The first issue is thus to monitor a wide enough spectrum of frequencies. This can be done through commercially available spectrum analyser and suitable antennas. Next issue is to locate a specific transmitter.

Known methods to locate transmitters include angle of arrival (AOA) through time difference of arrival (TDOA) measurement from two or more antenna elements or signal strength measurement of a directional antenna. Range to the transmitter might be found through difference in the power of the received signal strength (RSS) as compared to the originating signal strength. More complex methods have also been described in prior art, for example in WO 2009102834 A1 (McPherson et. al.).

When a wireless device is spotted, the challenge is to locate it without cooperation of two or more listening nodes. Assuming co-location of receiver and transmitter (a transceiver), for instance a cellular phone, the issue becomes finding the position of the transmitter. This is disclosed through prior art patent documents, like US 2004/0029558 A1 (Liu), WO 2009102834 A1 (McPherson et. al.) and also through US 2015/0168534 A1 (Holte) for arbitrary type of transmitter. U.S. Pat. No. 9,341,698 B1 (Sierens) describes the location of a single transmitter.

Location of e.g. a remotely controlled drone which is only receiving radio, not transmitting, is made through visually searching the sky and by homing in as above on the reflected radio waves from the drone. The received radio power level is thus relatively low, so it is most likely to be used at short range and where the background radiation is low.

The second capability above, jamming of the wireless device, is well known to a person skilled in the art. Jamming can be employed in many different types, method or shapes. Early jammers were often simple transmitters keyed on a specific frequency thereby producing a carrier frequency which interfered with the normal carrier frequencies at targeted local receivers. Such single carrier jammers have however become ineffective and easily avoided using, for example, frequency hopping, spread spectrum, and other technologies. Wide band radio frequency spectrum transmitters and various audio tone transmissions to jam or spoof local receivers have also been used.

In a continuous-wave operation, when a jammer is only transmitting a steady carrier, the jamming signal beats with other signals and produces a steady tone. In the case of single side band (SSB) or amplitude modulated (AM) signals, a howl sound is produced at the receiver. In the case of frequency modulated (FM) signals, the receiver is desensitised, meaning that the receiver's sensitivity (ability to receive signals) will be greatly reduced.

Other systems employ frequency tracking receivers and transmitters to effectively follow and jam each frequency a frequency hopping system might use. Some sophisticated jammers feature several modes of operation and several modulation types.

Some jamming solutions for specific purposes are described in prior art patent documents such as US 2006/0060074 A1 (Ham et. al), US 2009/0237289 A1 (Stoddard), US 2012/0045984 A1 (Cornwell) and US 2005/0168375 A1 (Hallday et. al).

Software-defined radio (SDR) is a device for radio communication where components typically implemented in hardware (e.g. mixers, filters, amplifiers, modulators, demodulators, detectors) are instead implemented by means of software on a general purpose digital computational device.

An SDR system can receive and transmit widely different radio protocols, also known as waveforms, based solely on the software used. Cognitive radio is an application where SDR is useful. In such systems, each radio measures the spectrum in use and communicates this information to other cooperating radios, in order for transmitters to avoid mutual interference. By selecting unused or unjammed frequencies the radio becomes more robust to jamming. This selective type of frequency use is especially valuable for military usage in a jammed environment.

The present invention relate, according to an aspect thereof, to a method to detect and jam an electromagnetic transmission where the following steps are followed;

detect electromagnetic radiation from an electromagnetic radiating source,

determine the type of the received electromagnetic radiation by comparing the signature of the received signal with signatures from a database,

select the waveform and frequency to disturb the determined type,

transmit a waveform with a frequency to jam the electromagnetic transmission.

According to further aspects of the improved method to jam an electromagnetic transmission, provision is made as follows:

the waveform and frequency to disturb the electromagnetic transmission are selected from a database.

the waveform and frequency to disturb the electromagnetic transmission are selected so that the frequency is identical to the detected frequency and that the waveform is white noise.

the waveform and frequency to disturb the electromagnetic transmission are selected so that the frequency is identical to the detected frequency and that the waveform is Gaussian noise.

the geographic location of the wireless device is determined.

the geographic location of the wireless device is determined by measuring the highest received signal power of the electromagnetic transmission. Another way to determine the angle of the received wave from is by pseudo-doppler technique, also known as Pseudo Doppler Radio Direction Finding, or SDRDF. In SDRDF rapid electronic switching between a numbers of transmitting antennas simulate a rapidly moving wheel-structure with antenna elements. The phase difference of the pseudo-doppler signal is then measured, as a received signal, against a known reference. The pseudo-doppler signal is introduced (superimposed on the demodulated signal) by electronically rotating the antenna array against a reference signal of the same frequency as half the switching rate.

information about the target wireless device is presented in a man-machine-interface display.

It is determined how to battle an unknown target by using the detected information of the target to deduce type of transmission protocol and type of device and decide appropriate jamming technique depending upon the type of transmission protocol and type of device. The present invention will, according to an aspect thereof, through pre-defined rules, by its own determine suitable waveforms and other parameters to be used for the jamming. Against an advanced target wireless device, the strive is to copy the original transmission as closely as possible but infer errors to the transferred data, thereby preventing the target of being alerted of the jamming. For simpler type of radio coding, the system might decide to use e.g. white gaussian noise if it is close enough to overwhelm the target wireless device with sheer power.

The present invention also relates, according to an aspect thereof, to a system for detecting and jamming an electromagnetic transmission wherein means are arranged to detect electromagnetic radiation from an electromagnetic radiating source, and where the type of the received electromagnetic radiation is determined in the system by comparing the signature of the received signal with signatures from a database, and where the waveform and frequency to disturb the determined type of the received electromagnetic radiation is selected, and a waveform is transmitted with a frequency to jam the electromagnetic transmission.

According to further aspects of the improved system for detecting and jamming an electromagnetic transmission, provision is made as follows:

the means to detect electromagnetic radiation is at least one antenna.

the means to detect electromagnetic radiation is at least one D-dot sensor.

the means to detect electromagnetic radiation is at least one B-dot sensor.

the system to detect and jam an electromagnetic transmission comprises at least two antennas and that the main lobes of each of the antennas are arranged to not coincide.

the system to detect and jam an electromagnetic transmission comprises three antennas and that the main lobes of each of the three antennas are arranged to be perpendicular to each other.

The present invention also relates, according to an aspect thereof, to a method to automatic detect and jam an electromagnetic transmission comprising the steps; i) detect electromagnetic radiation from an electromagnetic radiating source, ii) receive the detected electromagnetic radiation, iii) store the received electromagnetic radiation signal, iv) transfer the stored electromagnetic radiation signal to a machine learning function, v) classify and/or identify the detected electromagnetic radiation signal with a machine learning function, vi) select a waveform and frequency to be used to disturb the electromagnetic radiation source, vii) transmit a waveform with at least one frequency as selected to jam the electromagnetic transmission. Machine learning is a field of computer science that uses statistical techniques to give computer systems the ability to “learn” (e.g., progressively improve performance on a specific task) with data, without being explicitly programmed. A machine learning function thus contain information, such as a database, of relevant information of electromagnetic transmissions. The information could be waveform and frequency.

In one embodiment of an aspect of the invention also one or more field sensors, like B-dot and/or D-dot probes are inferred in the aspect of the invention. These sensors are very wide band and are especially suitable to detect near field radiation of low frequency, hence long wavelength, radio transmissions in the vicinity of an aspect of the invention. These frequencies otherwise demand a physically large conventional antenna for the lowest frequencies to be monitored. The field sensors might offer a small geometry design to detect the lowest frequencies in an aspect of the present invention frequency detection bandwidth.

Serving as an example of field sensors, the B-dot probe measures the time derivate of the tangential magnetic field component at the surface of a conductor. I.e. measuring the time rate of change of the surface current per unit length, where the unit length is perpendicular to the direction of current flow. This is typically achieved through a cylindrical loop, where the magnetic field induces a current in the conducting coil. The output voltage from the coil is dependent on the coil design parameters and the temporal characteristics of the magnetic field.

In one embodiment of an aspect of the invention a large Ultra-Wideband antenna, thus also covering lower frequencies, is used mainly for transmission purposes in which a low Voltage Standing Wave Ratio, VSWR, for all used frequencies is essential for good transmission. For reception, one or more smaller antennas are used in addition. The smaller antennas might also be active antennas, thereby increasing their performance significantly as recipients of radiation even outside their normal working frequency interval. In one embodiment, some, or all, of the “smaller antennas” can be B-dot or D-dot probes.

The large antenna is placed at one end (the front) of an aspect of the invention, whereas the smaller antennas are spread as far apart from each other as possible, thereby offering the largest possible measurement base for directional sensing, whatever technique used. The larger antenna can, in some embodiment of the invention, also be used for reception and contribute to the direction-finding ability.

As an example of antenna configuration, the large antenna is an Open Boundary Quad-Ridged Horn antenna, whereas the four smaller antennas placed partwise in the front and the back of the tube formed invention are Log Periodic antennas.

The disclosed method shows an improved method of jamming electromagnetic transmissions by always being able to form the best possible waveform to jam a target wireless device. Using the software defined radio wave forming technique it is possible to jam even the most jamming resistive radio protocols.

The best position to rapidly find a target and to be able to deliver a high power level at the target, is by being close to the target. The positioning advantage is due to relatively large changes of angle towards the target for a moving nearby transmitter location device. This can be understood when comparing two scenarios. One scenario where two points in space are closely together and the other scenario where the two points are distant. If one of the two points in each scenario move same distance orthogonal to an imagined straight line between the two points, then the non-moving point will experience a different angle between the starting position and the end position of the other point depending on scenario. The scenario where the two points are relatively close will experience the largest change of angle.

The relatively higher power level at the target is achieved through less damping of the propagating radio wave as compared with distant conventional jamming devices.

Conventional location and jamming systems, working at a larger distance from the targets, needs to have much higher inherent positioning accuracy and much higher jamming power in order to achieve similar positioning accuracy and jamming power as offered by present invention.

Another advantage with present invention is short delays from received signal at the invented device until the jamming signal is present at the target wireless device. This will, dependent on geographical distance, be favourable as compared to a distant jammer when it comes to available time to jam a fast frequency hopping radio with very short dwell time in each used frequency bin.

The invented device is thus able to be much more success fill in locating and jamming target wifeless devices in its vicinity even than more powerful conventional locating and jamming devices at a larger distance from target.

The database with information of how to jam known wireless devices ensure best known jamming method to be used. For adaptive systems, like cognitive radios, the invented device will follow the waveform changes of the target system and adopt the jamming waveform accordingly.

### BRIEF DESCRIPTION OF FIGURES

The invention is described in more detail below with reference to the attached figures, in which:

FIG. 1 shows the present invention in a principle embodiment where it is clear that it is a portable man carried system with means to control the device and read information from it. Furthermore, it is also illustrated that one or more antenna is part of the invention. The use of three antennas in this illustration of an embodiment is used to help the understanding of FIG. 2.

FIG. 2 shows a sample usage of the invention. It is illustrated that in one example embodiment three different antenna lobes are used to locate a transmitting wireless device. In this embodiment, the highest signal level received by any of the three antennas gives information about which of the three antenna lobes is the one being best directed towards the target position. The illustration could also be conceived as one antenna directed in three different positions where the received signal strengths from the three samples are compared in order to find the most correct direction to target.

FIG. 3 shows a typical sequence from detection to action. The major steps being detection-evaluation-action. A more detailed step sequence is dependent upon the embodiment.

FIG. 4 shows levels of abstraction in computing. The lower computational level in the figure, the closer to hardware. The waveforming computations being the most time-critical.

FIG. 5. Shows a sample graphical presentation of target object—black dot, with a circular estimate of the position error—the dashed circle. On some embodiment, the dashed circle can be replaced with a colored shape showing the uncertainty area.

FIG. 6 shows a graphical view of the system configuration in one embodiment of the invention. The “target characteristics database” outlined in FIG. 4, being the I. level of the database in this figure. This level contains the information to be used by present invention to identify and classify a received radio transmission. The II. level contains information about each wireless communication system which is not directly related to the transmission by itself. The third layer III. contains recently collected intelligence related to each wireless communication system. The arrows show in which direction the major information flow goes typically between each segment of the database and the central processing units, CPU, for essential functions of the invention. From the CPU the information is transferred to and from the database and other exemplified logical or physical entities of the invention.

### DETAILED DESCRIPTION

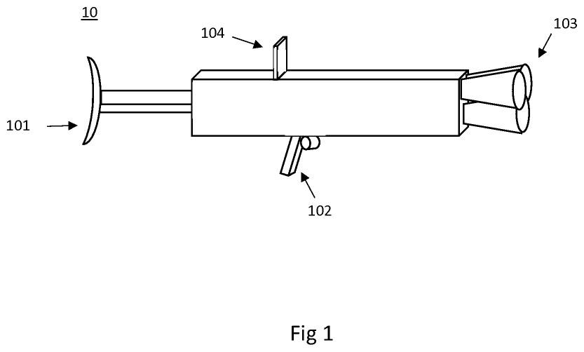

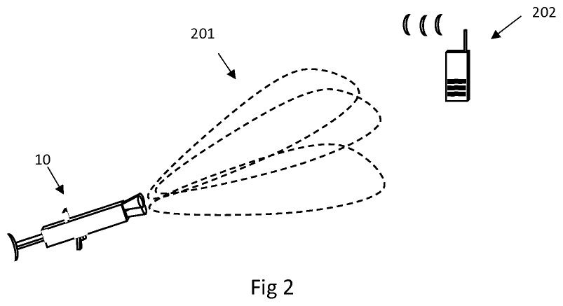

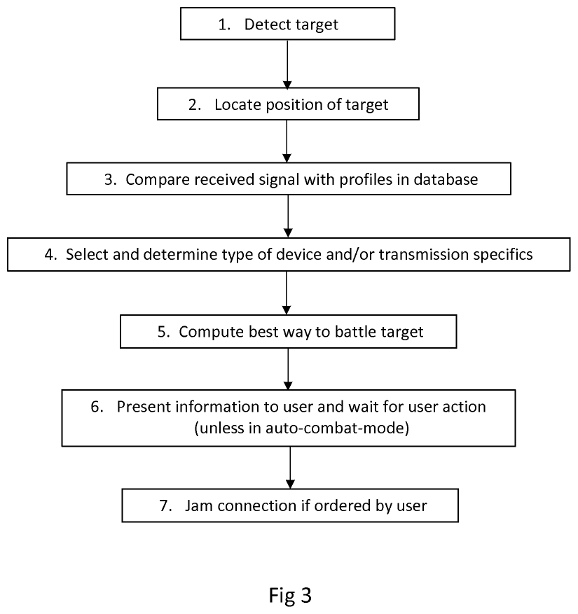

The present invention, hereafter named the detection and transmission system 10, relates to a man-portable or platform carried device in principle depicted in FIG. 1 where shoulder rest 101, hand grip and control device 102, antennas 103 and display 104 can be seen. This is just an exemplification of how a basic embodiment of the invention could look like, the components comprising the detection and transmission system could be varied. The detection and transmission system incorporates the ability to determine the existence and position of one or more wireless devices. This is shown in FIG. 2 where invented system 10, antenna lobes 201, target wireless device 202 is illustrated to get an appreciation of how the detection and transmission system can locate a target. Furthermore, the detection and transmission system incorporates the ability to compute, use and present known intelligence or information data related to the detected wireless devices and the ability to jam the radio connection to one or more of the detected wireless devices. A typical sequence is illustrated in FIG. 3:

Step 1—detection 1. The detection and transmission system receives electromagnetic radiation from a transmitter. The frequency, polarization, modulation type etc. of the received radiation is stored to be used later in the sequence.

Step 2—location 2. The detection and transmission system determine the geographic location 2 of the wireless device. This can be attained in different ways, but to make the explanation simple, assuming a sample embodiment with one antenna. The detection and transmission system will, in this simplified explanation, measure signal strength towards the transmitter at the same time the direction of the transmission and detection system is changing. For an antenna with directivity, the direction along the main lobe of the antenna with highest received signal power will also be the direction towards the transmitter. Other embodiments, with more than one antenna might also use location techniques described in prior art.

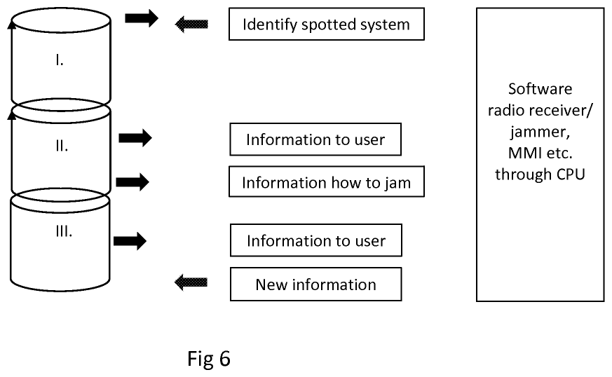

Step 3—compare with database 3. The information gathered in Step 1 is used to find a match between collected information in Step 1 and á priori information about known signalling systems contained in the transmission and reception system's database. What is described as one database above essentially consists of or comprises several layers of information. The system is configured as shown in FIG. 6, where the first level of database information (I.) is measurable parameters of different wireless communication systems, i.e. the full transmission protocol including used frequencies and polarizations used. This layer is primarily used to find a match with received radio signal. Next layer in the database consists of or comprises other information regarding each wireless communication system (II.) including what measures to take if jamming is required by user. This is further information about each communication system, e.g. known usage of this particular communication system, which kind of hardware is known to be used with this communication system etc. The third layer (III.) contains recent gathered intelligence information. E.g. what type of military unit to use a new particular communication system, or, in a civilian police context when detecting a cell phone, a list of cell phone numbers already known to be of possible interest for the police user.

A generally applicable solution to determine the characteristics of the detected wireless communication system is to use Machine Learning technologies, like Deep Learning. This approach can even avoid the need for a conventional threat database and rely on training of one or more neuronal nets for identification and classification of the wireless communication system. The neuronal nets can in one embodiment be directed towards frequency intervals to be analysed by conventional spectrum power density scanning, or similar techniques. Machine Learning techniques is also applied to determine the measures to take against the target by the transmission and reception system. This approach is applicable against all types of wireless communication systems, not just the ones where a priori information is available, but also for wireless communications systems with unknown characteristics, possible to incorporate in e.g. SDR radio.

In order to suppress as much unwanted communication as possible, an automatic procedure to apply disturbing measures without the delay of man-in-the-loop is needed for the transmission and reception system. The transmission and reception system will thus rely on pre-determined rules of engagement from the operator and post-engagement information to the operator.

Step 4—select 4. When one or more match occurs, the full information record about the assumed detected target system(s) are retrieved from the database by selection or classification. If only one system is detected, then it is a match. If the detected emission is ambiguous, the database information of the now shortlisted systems contributes with information of what to specifically search for in the detection phase in order to finally determine the type of detected target. In this step, also other type of information about the target is collected, e.g. the identity of a specific cellular phone. If no match occurs, the target is assumed to be an unknown wireless system and a new record in the database is added and the detected information about the target wireless device is fed into the record.

Step 5—how to battle target 5. In case no record exists, for a new unknown target wireless device, the detection and transmission system will have to make a best guess. In this case, the transmission and detection system will use the detected information of the target to deduce type of transmission protocol etc. and device an appropriate jamming technique out of this.

Step 6—present information 6. The information about the target wireless device is presented, more or less extensively dependent on user settings, to the user, through the man-machine-interface display 104. The user might also through the hand grip and control device 104 command the transmission and detection system to take measures against the target wireless device.

Step 7—jam connection 7. If allowed to do so, by user command, the transmission and detection system will jam the target wireless device by transmitting an electromagnetic jamming signal from the transmission and detection system. The procedure and measures to battle the target is also retrieved from the database record for this particular target wireless device. In some cases, it is not the location where the transmitter is positioned which is to be jammed, but another object which is radio controlled by the transmitter, e.g. remotely controlled drone.

In this conception of jamming, also deceptive signalling, intended to send false information to one or more of the detected wireless devices is included. Deceptive signalling can for example be used to deceive a satellite navigation system. A typical example is when trying to stop a sophisticated aerial drone. If the remote-control link to the drone is jammed, in some cases the drone will still be flying according to its pre-programmed flight path. The invented system will thus mimic the satellite navigation signal, for instance by repeating the original satellite signal with a delay at a higher power level than the legitimate signal to the aerial drone. The result will be that the satellite receiver in the drone will be offset from its real geographical position and will hence fly in a different direction or altitude than the pre-programmed one.

The detection and transmission system will radio-wise operate in two functional modes. A first mode, a listening only mode, and a second mode, an alternating listening and jamming mode. The latter mode, the second mode, makes it possible to jam frequency hopping wireless devices or other devices with varying frequency, amplitude etc. A third jamming mode is also possible when the detection and transmission system transmit a jamming signal.

The system uses SDR both for reception and transmission. At least one antenna is incorporated in the platform. In different embodiments of the invention the antennas could be used in any combination for transmission and reception.

The information collection is undertaken by several built-in electromagnetic sensors, such as antennas. One or more broadband antennas connected to one or more SDR collect information from the electromagnetic spectrum where the SDR operate (AOA or similar for direction. Range from RSS or similar). A satellite navigation (satnav) (e.g. GPS, GLONASS or GALILEO) receiver together with inertial navigation system (INS) supply full 6 degrees of freedom (6-DOF) position and orientation data of the system. A man-machine interface (MMI) supply user input and system output, either directly or through a data link from another MMI. The detection and transmission system might in one embodiment advice the user how to move (direct) the detection and transmission system in order to improve system performance.

An INS system in this text is a navigation “black box” with motion sensors (accelerometers), rotation sensors (gyroscopes) and a computing capacity to continuously calculate, through dead reckoning or other means, the position, orientation, and velocity (direction and speed of movement) without the need for external references.

The 6-DOF in this text refer to the freedom of movement of a rigid body in three-dimensional space, as the body is free to change position as forward/backward, up/down; left/right translation in three perpendicular axes, combined with changes in orientation through rotation about three perpendicular axes, often termed pitch, yaw, and roll.

An MMI in this text is a hardware and/or software which allows the operator to control and monitor the machine functions, e.g. a touch screen display.

Computing of information is undertaken at several levels of abstraction. This is shown in

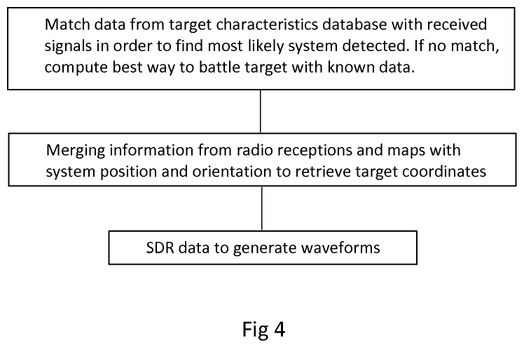

FIG. 4. In the lowest abstraction level the SDR data is processed in order to receive and transmit wanted radio signals. The waveform is determined through software.

A higher level of abstraction of information computing occurs when merging data from the radio sensors with the 6-DOF navigational data from the satnav-INS sensors. Calculated at an adjustable pace, this information at each sample time gives the estimated relative position of the detection and transmission system and the targeted wireless device. As the detection and transmission system is moved, the radio sensors will supply different information of angle and/or range to the target. This information is collected and when the information is fusioned, or in another way aggregates, it will provide an improved position solution.

To the information fusion described above is also geographical information in 2 dimensions and/or 3 dimensions added in order to supply an absolute geographic position of the target wireless device.

In one embodiment, the detection and transmission system also contains a database over possible types of radio transmitters and information of their characteristics (e.g. used frequency, waveform, known users etc.) as shown in FIG. 6. When comparing the collected radio data with the content of the database, the type of wireless device could be identified. This information is available for the user through the system MMI and is also used in the detection and transmission system's decision process to decide on what active measures in the form of jamming that might be taken against the target.

If no prior knowledge exists for a detected wireless device the collected information is a) stored in a database for later data processing/transfer and b) the detection and transmission system uses the collected information together with pre-stored information in the database to make a best guess about the wireless device and how to jam it.

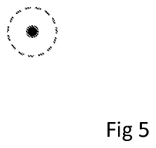

The information can be presented, on/in the MMI, in a number of ways, e.g. as circular coloured uncertain zones centred on each targeted wireless device, showing the estimated position and its position uncertainty superimposed on a map (illustrated in FIG. 5 without the superimposed map) or in text. Even synthetic speech and voice command might be used.

The collected data might be combined with á priori data in order to give information about one or more wireless devices. E.g. a specific cellular phone can be marked, followed and jammed. Another example is when a certain type of wireless device is known to belong to a special military unit, and that information will thus be presented to the user if such a wireless device is detected.

The level of detail presented through the MMI is user adjustable and span from very detailed information to an automatic target engagement mode. In this mode, all wireless devices determined as hostile by the system, will be blocked, jammed or interfered

An example of the usage of the automatic mode is when the detection and transmission system detects and classifies the transmission of an incoming artillery proximity fuse used by artillery shells to achieve airburst. It is then of uttermost importance to instantly start jamming the fuse in order to prevent the shell from detonating in the air, without delay of man-in-the-loop procedures.

The detection and transmission system will rely on sophisticated jamming, rather than the simple single carrier frequency jammer. It will utilize the ability of the SDR to produce an arbitrary waveform and be adaptive to the type of communication to interrupt or deceive the communication. The specific jamming to employ against a certain wireless device is either to find in a look-up database where known communication systems and a pre-determined way to jam the communication systems is stored, or calculated/decided by the detection and transmission system in an intelligent manner against unknown types of communication. The capability to calculate and/or decide the way to jam the communication system are being increasingly likely to be used in the future, as SDR, with the ability to rapidly switch radio communication parameters drastically is growing, especially for military applications.

Noteworthy is that in one embodiment of the invention the detection and transmission system will have the ability to “hijack” the original transmission to the wireless device, by overwhelming the original external signal with an almost similar transmission, but with higher radiated power at the wireless device than the original external signal, and substitute the original message with other information to be determined by the detection and transmission system user.

One major hurdle to overcome for a wideband transmitter is the ability to efficiently transfer electrical power to radiated power on all frequencies, due to mismatch at the antenna feed. This is caused by widely different impedances of the feed and the antenna at some frequencies. Reconfigurable or smart antennas can be used in some embodiment of the invention, offering it better electrical to radiated power ratio over the whole working frequency range, as compared with an un-configurable antenna.

Reconfigurable antenna is an antenna type capable of dynamically modifying its frequency and radiation properties in a controlled and reversible manner. Reconfigurable antennas integrate an inner mechanism (e.g. varactors, RF switches, mechanical actuators etc.) which allow adjustment of the RF currents over the antenna surface and generate reversible modifications of its properties. Reconfigurable antennas differ from smart antennas since the reconfiguration mechanism is placed within the antenna rather than in an external beamforming network.

In one embodiment of the invention the one or more antennas have intentionally been given a small voltage standing wave ratio (WSWR) in one or a few picked or selected frequencies, thus being considered to be resonant frequencies. Hence enabling good reception and transmission ability for those specific frequencies. Other frequencies will not be considered resonant, even if they might still be usable, however with lower electrical to radiated power ratio.

It is often beneficial, especially in the military context, to be non-radiating. The detection and transmission system is thus for its basic operation not relying on being wirelessly linked to one or more network nodes. In one embodiment of the invention the ability to communicate with other detection and transmission systems and/or a communication network is however added, thus giving the detection and transmission system the ability to transmit and receive information in real-time. This might be, but is not restricted to, target bearings, software updates and collaboration tactics between two or more detection and transmission systems.

In another embodiment of the detection and transmission system it can also be used as a radar system. By using the ability to transmit and receive in a short timeframe the system is able to detect objects on water, land and in the air. Moving targets can be detected through doppler measurement. These abilities are achieved through software in the detection and transmission system. Examples on usage is detecting and predicting where inbound artillery shells will hit and target location of sea vessels from land in darkness.

In a typical scenario, the detection and transmission system is first activated in a listening mode. It will then monitor all frequencies within its operational frequency range. When a transmission from a wireless device is detected the system will gather all information about the wireless device the detection and transmission system is capable of retrieving. What parameters to collect is dependent upon embodiment of the invention. Frequency (or frequencies) used is mandatory. Other parameters to be measured, dependent upon embodiment, are wave forms, polarization, modulation, bit rates etc.

The detection and transmission system determine the geographic location of the transmitter. In order to make the explanation simple, assuming a sample embodiment with one antenna. The detection and transmission system measure signal strength towards the transmitter at the same time the direction of the transmission and detection system is changed. For an antenna with directivity, the direction along the main lobe of the antenna with highest received signal power will also be the direction towards the transmitter. Other embodiments, with more than one antenna might also use location techniques described in prior art.

The information gathered in listening mode is used to find a match between collected information and á priori information about known signalling systems contained in the transmission and reception system's database. When one or more match occurs, the full information record about the assumed detected target system is retrieved from the database. If only one system is detected, then it is a match. If the detected emission is ambiguous, the database information of the now shortlisted systems contributes with information of what to specifically search for in the detection phase in order to finally determine the type of detected target. Other type of information about the target is also collected, e.g. the identity of a specific cellular phone, as shown in FIG. 6. If no match occurs, the target is assumed to be an unknown wireless system and a new record in the database is added and the detected information about the target wireless device is fed into the record.

For an unknown target wireless device, the system will have to make a best estimate. In this case, the transmission and detection system will use the detected information of the target to deduce type of transmission protocol etc. and calculate an appropriate jamming technique out of this. Machine learning techniques, like Deep Learning, where a trained neuronal net is fed with the input signal, e.g. I and Q channels, and feed directives to the SDR how to jam the target wireless device.

The information about the target wireless device is presented, more or less extensively dependent on user settings, to the user, through the man-machine-interface 102. The user might also through the control device 104 order the transmission and detection system to jam the target wireless device.

The procedure and measures to jam the target is also retrieved from the database record for a particular target wireless device. In some cases however, it is not the location where the transmitter is positioned at which the jamming effort is directed, but another object which is radio controlled by the transmitter, e.g. a remotely controlled drone.

The invention is not limited to the particular embodiments shown but can be varied in different ways within the scope of the patent claims. For example the number of antennas, used frequency etc. could be varied. The invention is neither limited to radio communications but could be used for other electromagnetic or other communication such as optical, audio etc., audio etc.

1. A method to automatic detect and jam an electromagnetic transmission comprising the following steps;
detecting electromagnetic radiation from an electromagnetic radiating source,
determining the type of the received electromagnetic radiation by comparing the signature of the received signal with signatures from a database,
selecting the waveform and frequency to disturb the determined type, transmit a waveform with a frequency to jam the electromagnetic transmission.

2. A method to detect and jam an electromagnetic transmission according to claim 1, wherein the waveform and frequency to disturb the electromagnetic transmission are selected from a database.

3. A method to detect and jam an electromagnetic transmission according to claim 1, wherein the waveform and frequency to disturb the electromagnetic transmission are selected so that the frequency is identical to the detected frequency and that the waveform is white noise.

4. A method to detect and jam an electromagnetic transmission according to claim 1, wherein the waveform and frequency to disturb the electromagnetic transmission are selected so that the frequency is identical to the detected frequency and that the waveform is Gaussian noise.

5. A method to detect and jam an electromagnetic transmission according to claim 1, wherein the geographic location of the wireless device is determined.

6. A method to detect and jam an electromagnetic transmission according to claim 5, wherein the geographic location of the wireless device is determined by measuring the highest received signal power of the electromagnetic transmission.

7. A method to detect and jam an electromagnetic transmission according to claim 1, wherein information about the target wireless device is presented in a man-machine-interface display.

8. A method to detect and jam an electromagnetic transmission according to claim 1, wherein it is determined how to battle an unknown target by using the detected information of the target to deduce type of transmission protocol and type of device and decide appropriate jamming technique depending upon the type of transmission protocol and type of device.

9. A system for detecting and jamming an electromagnetic transmission wherein means are arranged to detect electromagnetic radiation from an electromagnetic radiating source, and where the type of the received electromagnetic radiation is determined in the system by comparing the signature of the received signal with signatures from a database, and where the waveform and frequency to disturb the determined type of the received electromagnetic radiation is selected, and a waveform is transmitted with a frequency to jam the electromagnetic transmission.

10. A system for detecting and jamming an electromagnetic transmission according to claim 9, wherein the means to detect electromagnetic radiation is at least one antenna.

11. A system for detecting and jamming an electromagnetic transmission according to claim 9, wherein the means to detect electromagnetic radiation is at least one D-dot sensor.

12. A system for detecting and jamming an electromagnetic transmission according to claim 9, wherein the means to detect electromagnetic radiation is at least one B-dot sensor.

13. A system for detecting and jamming an electromagnetic transmission according to claim 10, wherein system to detect and jam an electromagnetic transmission comprises at least two antennas and that the main lobes of each of the antennas are arranged to not coincide.

14. A system to detect and jam an electromagnetic transmission according to claim 13, wherein system to detect and jam an electromagnetic transmission comprises three antennas and that the main lobes of each of the three antennas are arranged to be perpendicular to each other.

15. A method to automatic detect and jam an electromagnetic transmission comprising the following steps;
detecting electromagnetic radiation from an electromagnetic radiating source,
receiving the detected electromagnetic radiation,
storing the received electromagnetic radiation signal,
transferring the stored electromagnetic radiation signal to a machine learning function,
classifying and/or identifying the detected electromagnetic radiation signal with a machine learning function,
selecting a waveform and frequency to be used to disturb the electromagnet radiation source,
transmitting a waveform with at least one frequency as selected to jam the electromagnetic transmission.
